(19) United States
(12) Patent Application Publication
(10) Pub. No.: US 2025/0343305 A1
(43) Pub. Date: Nov. 6, 2025

(54) Battery Housing, Battery, and Method for Producing a Battery Housing

(71) Applicant: Bayerische Motoren Werke Aktiengesellschaft, Muenchen (DE)

(72) Inventor: Franz GASSNER, Oberlauterbach (DE)

(21) Appl. No.: 18/867,508

(22) PCT Filed: Aug. 25, 2023
(86) PCT No.: PCT/EP2023/073353

§ 371 Date: Nov. 20, 2024

(30) Foreign Application Priority Data
Sep. 14, 2022 (DE) 10 2022 123 496.7

(51) Int. Cl. H01M 50/124; H01M 10/04; H01M 50/119; H01M 50/121; H01M 50/143

(52) U.S. Cl. CPC H01M 50/1245; H01M 10/04; H01M 50/119; H01M 50/121; H01M 50/143

(57) ABSTRACT

A battery housing has at least one metal plate, wherein at least one surface of the metal plate is coated with a cathodic electro-deposition coating. The cathodic electro-deposition coating contains at least one flame-retardant pigment.

### BACKGROUND AND SUMMARY

The invention relates to a battery housing with low ignitability and to a battery with reduced flammability. In addition, the present invention also relates to a method for producing a battery housing with low ignitability.

For reasons of corrosion protection, battery housings are conventionally coated with a cataphoretic dip coat (KTL). This coating has an organic base and is baked onto the surface to be protected at approx. 180° C. Rechargeable batteries that are currently used, in particular for electric cars, can generate a self-accelerating fire inside the rechargeable battery. In the case of such a fire, the temperature of the rechargeable battery increases sharply. The resultant heat can, owing to the organic base of the KTL, ignite the battery housing. Batteries and battery housings that are currently on the market therefore exhibit a high degree of ignitability and a high degree of flammability.

It is an object of the invention to provide a battery housing and a battery with reduced flammability. In addition, it is an object of the present invention to specify a method for producing a battery housing, by means of which a flame-retardant and thus application-safe battery housing can be produced.

These objects are achieved by the features of the independent claims. The dependent claims provide advantageous developments.

Accordingly, the object is achieved by a battery housing which comprises at least one metal plate. Within the meaning of the present invention, a battery housing is a housing which is designed to receive battery cells. The battery cells are not specifically restricted, but in particular comprise rechargeable battery cells, such as are used in particular for electric cars.

The battery housing is restricted neither in terms of shape nor size, but comprises at least one metal plate. Advantageously, the battery housing can be designed in the form of a container into which battery cells can be introduced, and can to this end also comprise two or more metal plates. The battery housing is provided to receive battery cells and to protect these against mechanical action. The battery housing is also protected against corrosion, namely due to the fact that a surface of the at least one metal plate is coated with a cataphoretic dipping lacquer.

The metal plate used can, for example, be a steel plate.

According to the present invention, a cataphoretic dipping lacquer is understood to be a lacquer which, as is conventional, is applied to a metallic surface by cathodic dip coating of a cataphoretic dip coat and was subsequently baked, such that all volatile components are evaporated and the lacquer is baked into the surface of the metal plate. Any chemical reactions of the components of the cataphoretic dip coat used for the dip coating are concluded with the baking operation and the cataphoretic dipping lacquer obtained from the cataphoretic dip coat after baking is distinguished by very good corrosion-inhibiting or corrosion-reducing properties which protect the metal plate of the battery housing and result in a long service life of the battery housing. In terms of these properties and the composition, the cataphoretic dipping lacquer applied according to the invention virtually does not differ from conventional cataphoretic dipping lacquers.

According to the invention, the cataphoretic dipping lacquer comprises at least one flame-retardant pigment. Flame-retardant pigments are known from the prior art and comprise halogenated pigments and halogen-free pigments. For environmental protection reasons, particular preference is given to halogen-free pigments. In this case, one or more flame-retardant pigments can be used in combination according to the invention. The flame-retardant pigments used according to the invention are distinguished by a good temperature stability at the processing temperature of the dipping lacquer, but exhibit a high flame-retardant effect at temperatures above about 700° C. and in particular at 800° C. to 1000° C.

Advantageously, the flame-retardant pigment is already introduced into the cataphoretic dip coat used for the coating of the metal plate by dip coating and thus becomes an integral element of the dipping lacquer obtained after the application and baking, such that a metal plate coated with this dipping lacquer is distinguished by high flame-retardant properties, as a result of which the battery housing has very good fire resistance. If multiple metal plates are present on the battery housing, the flame-retardant effect can be improved by virtue of all the metal plates being coated, in particular both on inner surfaces and outer surfaces, with the cataphoretic dipping lacquer comprising flame-retardant pigment.

According to an advantageous development, an outer surface of the metal plate is coated with the cataphoretic dipping lacquer. This efficiently prevents spreading of any fires and thus improves the user safety of the battery housing.

Further advantageously, the cataphoretic dipping lacquer contains further pigments with a maximum content, based on the total mass of the cataphoretic dipping lacquer, of 1% by mass, and in particular of 0.1% by mass. This means that the cataphoretic dip coat, which is used for coating the metal plate and forms the cataphoretic dipping lacquer after the application and baking, preferably has no further pigment added to it apart from the flame-retardant pigment.

Particularly preferably, the flame-retardant pigment is the only pigment in the cataphoretic dipping lacquer. The amount of pigments, with the exception of the flame-retardant pigment or pigments, in the cataphoretic dipping lacquer is thus essentially 0% by mass.

In order to prolong and to better control the flame-retardant effect, the flame-retardant pigment is preferably present in encapsulated form. The encapsulation also makes it possible to improve the corrosion protection effect of the cataphoretic dipping lacquer.

Flame-retardant pigments that can be used by way of example are selected from phosphinates, ammonium polyphosphates, zinc borate, triaryl phosphate, melamine phosphate, antimony trioxide, aluminum hydroxide, magnesium hydroxide and trialkyl phosphate. A particularly good flame-retardant pigment with very good environmental compatibility is aluminum diethylphosphinate. The flame-retardant pigment used in the battery housing described herein is thus preferably one comprising aluminum diethylphosphinate.

The cataphoretic dipping lacquer used for the battery housing can be formed like conventional cathodic dipping lacquers and preferably comprises at least one crosslinked resin in order to produce long-term corrosion protection and also a long-term flame-retardant effect. The resin is not specifically restricted and can be based on acrylates, polyurethanes, epoxides and the like. Further additives, such as fillers or additives such as in particular carbon blacks, aluminum and/or magnesium silicates, and/or pH adjusting agents, catalysts, wetting agents and the like, may also be present.

Furthermore, the invention also describes a battery which comprises a battery housing designed as above. The battery additionally contains in particular one or more battery cells, which are in particular rechargeable. The battery is in particular designed for use in electric cars. The use of the battery housing according to the invention for the battery according to the invention also provides a battery with high flame-retardant properties and thus very good user safety.

In addition, the invention also describes a method for producing a battery housing. The battery housing comprises at least one metal plate. In this case, the method comprises a step of coating at least one surface of the metal plate with a cataphoretic dip coat, wherein the cataphoretic dip coat comprises at least one flame-retardant pigment. Further additives, such as fillers such as carbon blacks, aluminum and/or magnesium silicates, pH adjusting agents, resins or resin precursors, crosslinking agents, catalysts; wetting agents, dispersing additives, solvents and the like, may also be present in the cataphoretic dip coat. In addition, the method comprises a step of baking the cataphoretic dip coat in order to stabilize it on the metal surface. All the metal plates of the battery housing are preferably coated with the cataphoretic dip coat. This can be effected on the inner side of the metal plates (facing toward the inside of the battery housing) and/or on the outer side of the metal plates (facing toward the environment of the battery housing). The baking is effected at temperatures which are suitable for stabilizing the lacquer on the metal surface. In the case of chemical crosslinking reactions, the temperature for the baking can be in particular 150° C. to 400° C. and in particular 170° C. to 250° C.

The flame-retardant pigments used according to the invention are distinguished by a good temperature stability at the processing temperature of the dip coat, that is to say even at baking temperatures of up to 400° C. However, the flame-retardant pigments exhibit a high flame-retardant effect at temperatures above about 700° C. and in particular in a temperature range from 800° C. to 1000° C., in which fires usually ignite a battery.

The advantages, advantageous effects and developments described for the battery housing according to the invention also apply to the method according to the invention for producing a battery housing. The method according to the invention can also be used to produce the battery housing according to the invention.

According to a further advantageous development, a total content of the flame-retardant pigment, based on the total mass of the cataphoretic dip coat, is 10% by mass to 20% by mass, and in particular 12% by mass to 19% by mass. Further preferably, the flame-retardant pigment is the only pigment in the cataphoretic dip coat. This means that the cataphoretic dip coat has no further pigments added to it apart from the flame-retardant pigment or pigments. The cataphoretic dip coat can thus be formed like conventional cataphoretic dip coats, but pigments that are usually used are replaced by one or more flame-retardant pigments.

To further reduce the flammability, all the outer surfaces of all the metal plates of the battery housing are advantageously coated with the cataphoretic dip coat.

Further details, features and advantages of the invention will emerge from the description below and from the FIGURE.

### BRIEF DESCRIPTION OF THE DRAWING

FIG. 1 shows a schematically depicted battery housing according to an advantageous development.

### DETAILED DESCRIPTION OF THE DRAWING

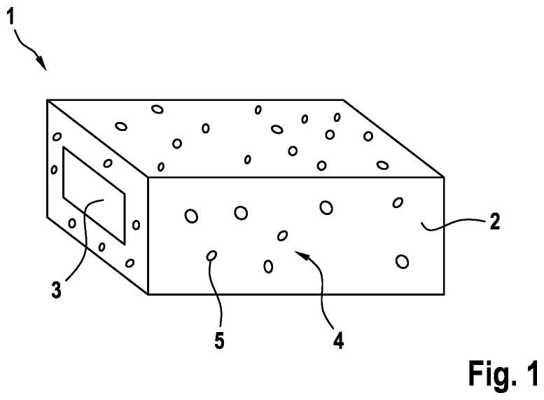

The present invention is explained on the basis of an exemplary embodiment. In this case, only the components that are essential to the invention are shown in FIG. 1. All the other components are omitted for the sake of clarity.

In detail, FIG. 1 shows a battery housing 1 which is of rectangular shape and comprises six metal plates 2. The metal plates 2 may be at least partially detachably connected to one another, in order to be able to introduce battery cells into the battery housing 1. The battery housing 1 may also comprise an electrical connection region 3 for electrically connecting the battery cells to a consumer.

The outer surfaces of the metal plates 2 are coated with a cataphoretic dipping lacquer 4. The latter was obtained by cathodic dip coating of a cataphoretic dip coat after baking of same and contains a flame-retardant pigment 5. The flame-retardant pigment 5 in particular comprises aluminum diethylphosphinate.

Due to the flame-retardant pigment 5, the battery housing 1 is distinguished not only by a high degree of corrosion protection but also by a high flame-retardant effect. The battery housing 1 thus offers a high degree of flammability protection and is distinguished by a high degree of user safety.

In addition to the written description of the invention above, reference is hereby explicitly made, for supplementary disclosure thereof, to the illustration of the invention in FIG. 1.

### LIST OF REFERENCE SIGNS

1 Battery housing
2 Metal plate
3 Electrical connection region
4 Cataphoretic dipping lacquer
5 Flame-retardant pigment

1.-10. (canceled)

11. A housing, comprising:
a battery housing comprising at least one metal plate, wherein
at least one surface of the at least one metal plate is coated with a cataphoretic dipping lacquer, and
the cataphoretic dipping lacquer comprises at least one flame-retardant pigment.

12. The housing according to claim 11, wherein
the at least one surface is an outer surface of the at least one metal plate coated with the cataphoretic dipping lacquer.

13. The housing according to claim 11, wherein
the cataphoretic dipping lacquer contains further pigments with a maximum content, based on a total mass of the cataphoretic dipping lacquer, of 1% by mass.

14. The housing according to claim 11, wherein
the cataphoretic dipping lacquer contains further pigments with a maximum content, based on a total mass of the cataphoretic dipping lacquer, of 0.1% by mass.

15. The housing according to claim 11, wherein the flame-retardant pigment is present in encapsulated form.

16. The housing according to claim 11, wherein the flame-retardant pigment comprises aluminum diethylphosphinate.

17. The housing according to claim 11, wherein the cataphoretic dipping lacquer comprises at least one crosslinked resin.

18. A battery comprising a housing according to claim 11.

19. A method for producing a battery housing, comprising:
providing at least one metal plate of the battery housing;
coating at least one surface of the metal plate by a cataphoretic dip coat and subsequently baking, wherein
the cataphoretic dip coat comprises at least one flame-retardant pigment.

20. The method according to claim 19, wherein
a total content of the flame-retardant pigment, based on a total mass of the cataphoretic dip coat, is 10% by mass to 20% by mass, and
the flame-retardant pigment is the only pigment in the cataphoretic dip coat.

21. The method according to claim 19, wherein
a total content of the flame-retardant pigment, based on a total mass of the cataphoretic dip coat, is 12% by mass to 19% by mass, and
the flame-retardant pigment is the only pigment in the cataphoretic dip coat.

22. The method according to claim 19, wherein all outer surfaces of all metal plates of the battery housing are coated with the cataphoretic dip coat.
